(19) United States
(12) Patent Application Publication
(10) Pub. No.: US 2017/0043665 A1
(43) Pub. Date: Feb. 16, 2017

(54) CONTROLLING HEATED WINDSHIELD LOAD TO ALLOW AND MAXIMIZE STOP-START AVAILABILITY

(71) Applicant: Ford Global Technologies, LLC, Dearborn, MI (US)

(72) Inventors: Hafiz Shafeek Khafagy, Dearborn, MI (US); Kirk Pebley, Novi, MI (US); Alan Douglas Wallington, Livonia, MI (US); William Joseph Wamsley, Canton, MI (US); James C Rollinson, Superior Township, MI (US)

(21) Appl. No.: 14/826,902

(22) Filed: Aug. 14, 2015

(51) Int. Cl. B60L 1/02

(52) U.S. Cl. CPC B60L 1/02; B60L 2240/44

(57) ABSTRACT

Methods for improving operation of a stop-start system of a vehicle include controlling an electrical load delivered to an electrically heated windshield (HWS) subsystem of the vehicle prior to a stop cycle or a start cycle of the stop-start system. The methods include steps of discontinuing the electrical load delivered to the HWS subsystem for a predetermined time period prior to a determined predicted stop cycle of the stop-start system. The methods further include differently apportioning the electrical load delivered to a passenger's side and a driver's side of the HWS subsystem. The differently apportioning may be according to a determined ambient temperature value, and further may include steps of differently apportioning the electrical load for predetermined time periods determined according to the ambient temperature value. Vehicle stop-start systems and vehicles implementing the methods are described.

### TECHNICAL FIELD

This disclosure relates generally to stop-start systems for a vehicle. In particular, the disclosure relates to systems for controlling an electrical load supplied to a heated windshield to maximize availability of vehicle stop-start systems.

### BACKGROUND

Vehicle stop-start systems (also referred to as idle stop systems) are used to improve fuel efficiency/economy by stopping/starting the vehicle engine during the drive cycle depending on engine status. For example, in a vehicle equipped with a stop-start system when the engine is idling or approaching idle, i.e. the vehicle speed approaches or is equal to zero or when the vehicle is coasting, the stop-start system automatically shuts down the engine. When the operator depresses the accelerator pedal (or the clutch in a vehicle equipped with a manual transmission) or releases the brake pedal, the stop-start system automatically and seamlessly restarts the engine. This reduces the amount of time spent at idle, likewise reducing fuel consumption and engine emissions. While most common in electric hybrid vehicles, stop-start systems are also found in vehicles lacking a hybrid electric powertrain, for example in so-called “mild” or “micro” hybrids including an internal combustion engine but no electric motor.

The three primary components of most stop-start systems are the vehicle engine, an electric starter/generator, and a battery. Particularly robust starters and batteries are required because of the frequent engine stop-start cycles incurred by stop-start systems. Stop-start systems are particularly reliant on the vehicle battery during the start phase of the cycle. Therefore, because of the number of vehicle components placing an electrical load on the battery and starter, control of power consumption is important in allowing a stop-start system to perform efficiently. This can be a particular issue for components that typically rely on the internal combustion engine for power but must continue to operate during a “stop” cycle of the stop-start system. This can include compressors, coolant pumps, windshield wipers, exterior/interior lights, entertainment/information systems, interior climate control systems, window defogger/demister systems, and others. The load imposed on the vehicle battery and/or the starter by such components can reduce efficiency of the system in restarting the engine, or in a worst case scenario may delay or impede restarting of the engine.

Vehicle components such as defog/defrost/demisting HVAC blower systems place a significant load on the vehicle electrical subsystems, which can be particularly disadvantageous during a stop cycle of a stop-start system. Further exacerbating the problem, it is known to provide a heated windshield (HWS) subsystem to aid the HVAC blower system in defrosting/defogging/demisting the vehicle windshield. Conventional electrical load management strategies call for activation of the HWS subsystem to aid in defrosting/defogging/demisting any time heated air is flowing to the windshield and ambient conditions are at a predetermined temperature value, for example less than 15° C. However, these systems create a significant current draw which can impair stop-start capability or even render it unavailable.

Thus, a need is identified in the art for improvements to vehicle stop-start systems. In particular, improvements to vehicle electrical load management during a start phase of a stop-start cycle are desirable.

### SUMMARY

In accordance with the purposes and benefits described herein and to solve the above-summarized and other problems, in one aspect methods are described for improving operation of a stop-start system of a vehicle by differently managing an electrical load supplied to a heated windshield subsystem of the vehicle. In particular, an electrical load supplied to a heated windshield subsystem of the vehicle is differently apportioned to a driver's side and a passenger's side of the windshield.

In embodiments, an electrical load supplied to the passenger's side of the heated windshield subsystem is reduced. In other embodiments, the electrical load is differently apportioned to the driver's side and passenger's side of the heated windshield subsystem according to determined ambient temperature. The electrical load may be differently apportioned for predetermined time periods. In still other embodiments, the predetermined time periods are determined according to the predetermined ambient temperature. Ambient temperature-dependent timers may be provided to time the predetermined time periods.

In other aspects of the disclosure vehicle stop-start systems and vehicles incorporating same for implementing the described methods are provided.

In the following description, there are shown and described embodiments of the disclosed stop-start electrical load management systems and methods. As it should be realized, the described systems and methods are capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed stop-start electrical load management systems and methods, and together with the description serve to explain certain principles thereof. In the drawings:

FIG. 1 is a block diagram representation of a vehicle including a stop-start system;

FIG. 2 is a flow chart representation of a method according to the present disclosure for improving operation of a vehicle stop-start system during a stop cycle; and

FIG. 3 is a flow chart representation of a method according to the present disclosure for improving operation of a vehicle stop-start system during a start cycle.

Reference will now be made in detail to embodiments of the disclosed systems and methods, examples of which are illustrated in the accompanying drawing figures.

### DETAILED DESCRIPTION

At a high level, the disclosed stop-start electrical load management systems and methods solve the above-described problems and improve efficiency of a vehicle stop-start system by differently managing an electrical load supplied to a heated windshield heated windshield subsystem of the vehicle. In particular, an electrical load supplied to a heated windshield subsystem of the vehicle is differently apportioned to a driver's side and a passenger's side of the windshield.

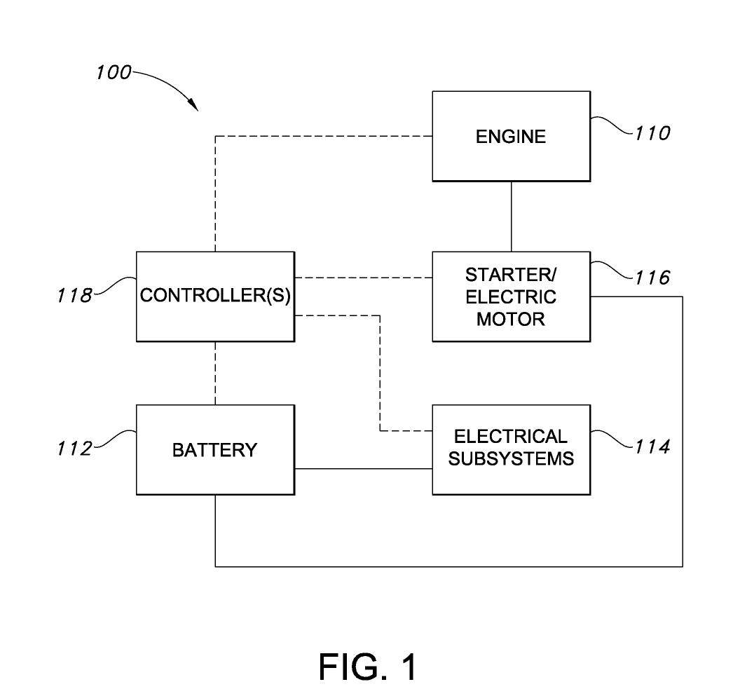

With reference to FIG. 1, a vehicle 100 including a start-stop system is schematically depicted in block diagram form. While stop-start systems are most commonly encountered in hybrid or micro hybrid vehicles, as noted above use of stop-start systems in non-hybrid vehicles is known and the use of the presently described methods and systems in non-hybrid vehicles is contemplated herein. The vehicle may include an engine 110, a battery 112, and a plurality of electrical subsystems 114 such as windshield wipers, exterior/interior lights, entertainment/information subsystem, interior climate control subsystem, window defogger/demister subsystem, heated windshield subsystem, and others. A starter/electric motor 116 may be included for restarting the engine 110 during a start cycle of the stop-start system.

One or more controllers 118 are provided which communicate (see broken lines) with one or more of the engine 110, starter 116, electrical subsystems 114, and battery 112. As is known, the controllers 118 may be configured to initiate an auto stop or auto start cycle of the stop-start system on receipt of a suitable signal, such as the vehicle speed decreasing to a predetermined value. Thus, as the vehicle 100 approaches a stop, at a predetermined speed (for example, 1-2 kph) the one or more controllers 118 may issue a command to begin a process of stopping engine 110. In that situation, fuel transfer to the engine 110 is discontinued, and starter 116 and electrical subsystems 114 rely on battery 112 for power. On receipt of a second signal, for example an operator releasing a brake pedal or depressing a clutch or accelerator pedal as discussed above, the one or more controllers 118 may issue a signal to reengage the engine 110

The stages of a vehicle stop-start system stop cycle and start cycle are known in the art, and do not require extensive discussion herein. However, a discussion of a representative stop cycle and start cycle of a stop-start system is provided in the present Assignee's U.S. Published Patent Appl. No. 2013/0041556, the entirety of which is incorporated by reference herein. Briefly, a stop cycle may include a phase of preparing for an impending engine 110 stop, including preparing various other vehicle systems and subsystems for operating on battery power only. Fuel flow to the engine 110 is discontinued, and the engine is stopped when the engine speed reaches 0 or near 0.

A vehicle start cycle may include a starter engage phase when the starter 116 attempts to restart the engine 110 in response to a start cycle indicator such as an operator releasing a brake pedal or depressing a clutch or accelerator pedal. When the engine 110 is able to crank under its own power, the starter 116 is disengaged. The engine increases speed to a target idle speed during an “engine speed increasing” phase. Once the engine reaches a speed at or above a target idle speed, the start cycle is finished.

During the stop cycle, certain of the electrical subsystems 114 may be disabled or at least have their functionality restricted to reduce drain on battery 112. For example, fully disabling the vehicle HVAC blower subsystem and/or the heated windshield subsystem would be disadvantageous under ambient conditions requiring continued windshield clearing. However, instantly restoring the full functionality of all disabled/functionality restricted subsystems 114 during the “engine speed increasing” phase may cause large drops in system voltage, potentially delaying or even preventing engine restart. Further, the electrical load required by particular subsystems such as window defrost/defog/demist subsystem, including heated windshield subsystem, may vary according to ambient temperature, i.e. the air temperature surrounding the vehicle 100.

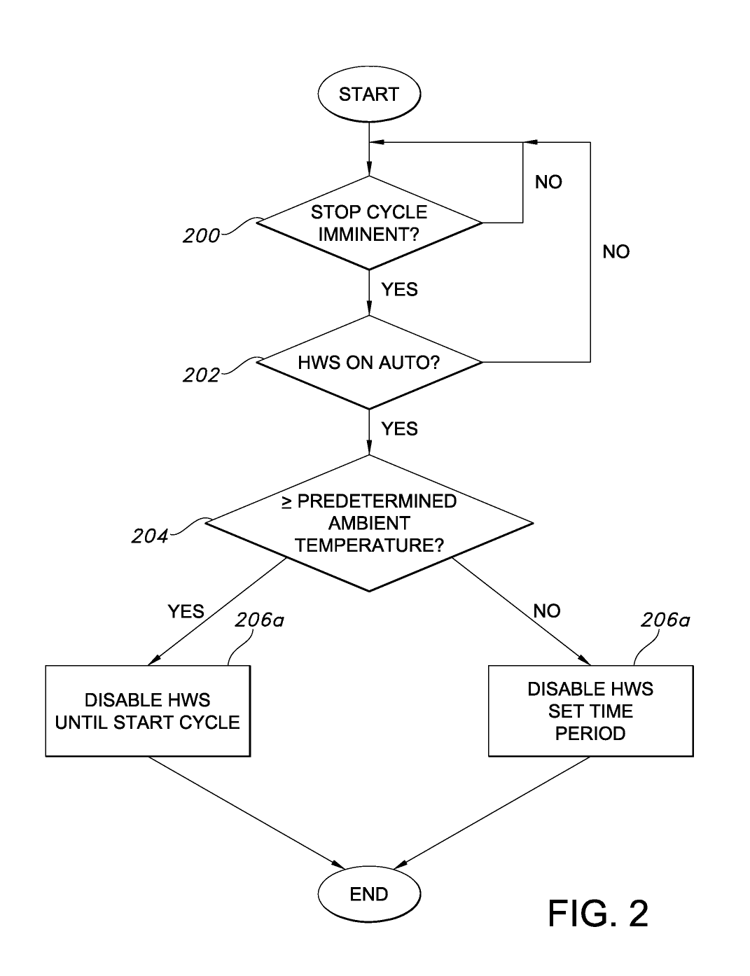

To address this problem, in one aspect there is provided a method for differently managing an electrical load supplied to a heated windshield subsystem of the vehicle. With reference to FIG. 2, the method includes a step 200 of determining whether a stop cycle of the stop-start system is imminent. If so, at step 202 it is determined whether the HWS subsystem is in “AUTO” or automatic mode. If so, at step 204 it is determined whether ambient temperature is at or above a predetermined value. If not, the system resets. If so, at step 206 the HWS subsystem is temporarily disengaged.

In an embodiment, controller area network (CAN bus) messaging indicates that a stop cycle is imminent, such as on determining that an engine speed is at or near 0 as described above, and the HWS subsystem is temporarily disengaged for a predetermined time period, for example 5-10 seconds, to allow the stop cycle to initiate without delay. An ambient temperature may be concurrently determined such as by a temperature sensor of known design. If the ambient temperature is determined to be at or above a predetermined value, such as 30° F. or higher, on completion of the stop cycle the HWS subsystem is disengaged and remains so until a start cycle is initiated (step 206a). In an alternative embodiment, if the ambient temperature is less than the predetermined threshold such that continued windshield clearing is required, it is further contemplated to adjust a maximum time of engine stoppage during which the HWS subsystem is disengaged to reduce risk of fogging, icing, etc., for example from 90 seconds to 2 minutes (step 206b).

Certain predetermined system overrides may be provided to further mitigate risk of fogging, icing, etc. by preventing shutdown of the HWS subsystem during a stop cycle. In embodiments, the overrides preventing shutdown of the HWS subsystem during a stop cycle may include one or more of a determined probability of fogging of 40% or more (FogProb<MaxAccFog), a vehicle operator manually actuating the vehicle defrost subsystem (defrost/max defrost actuated), a vehicle operator manually actuating the windshield wiper subsystem, a vehicle operator manually actuating the HWS subsystem, and others.

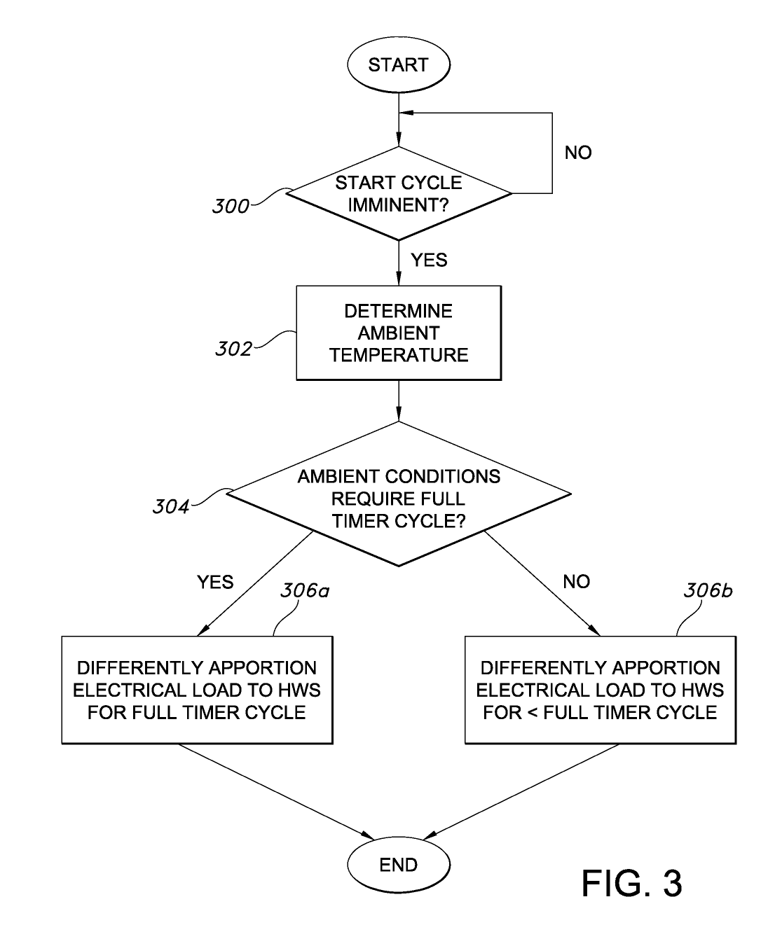

In turn, with reference to FIG. 3, at step 300 a determination is made of whether a start cycle of the stop-start system is imminent. At step 302 an ambient temperature is determined, again by a temperature sensor of known design. In accordance with the determined ambient temperature, at step 304 a determination is made of whether a full timer cycle determining a full time period of activation of the HWS subsystem is required. If so, at step 306a an electrical load is differently apportioned to different portions of the HWS subsystem for the full timer cycle. If not, at step 306b the electrical load is differently apportioned to different portions of the HWS subsystem for less than the full timer cycle.

By “differently apportioned” it is meant that an electrical load supplied to the HWS subsystem is differently provided to different portions of the windshield, i.e. the driver's side and the passenger's side of the windshield are treated differently. In an embodiment, the load provided to the passenger's side of the windshield is reduced. As will be appreciated, this allows the driver's side to receive more of the electrical load supplied to the HWS subsystem, and so the area of the windshield through which the driver must look is favored without having to increase the overall electrical load supplied to the heated windshield.

An embodiment of the above-described method is shown in Table 1 below, depicting proposed electrical loads at predetermined ambient temperature ranges. As will be appreciated, the percentages shown therein are a percentage of the maximum electrical load which could be provided to particular portions of the HWS subsystem. As shown therein, at temperatures between −18° C. and 15° C. a consistently greater portion of the 75% (of maximum) electrical load provided is supplied to the driver's side of the heated windshield.

TABLE 1
Proposed loads at ambient temperature during Auto-Stop

| Ambient temperature (° C.) | Driver side load | Passenger side load |
|---|---|---|
| ⁻18-0 | Up to 50% | Up to 25% |
| 0-15 | Up to 25% | Up to 15% |
| 15-31 | 0% | 0% |

In turn, it is contemplated to provide the above electrical loads for time periods determined by ambient temperature-dependent timers, in order to account for differing ambient conditions which may create a requirement for greater or lesser time periods of HWS subsystem activation. In an embodiment, as shown in Table 2 below various predetermined time periods are selected for user-selected actuation of defrost/max defrost functions, user-selected HWS subsystem actuation, and for automatic HWS subsystem actuation during a start cycle of a stop-start system. It will be appreciated that the values and ranges for temperature settings, timer settings, etc. are representative only and non-limiting, and may be adjusted as necessary by the manufacturer according to ambient conditions, geographic locations, and other factors.

TABLE 2
Proposed timer settings at ambient temperature during Auto-Stop

| | | | Timer for |
|---|---|---|---|
| Ambient | Timer for user | Timer for Max | Auto HWS |
| temperature (° C.) | selection (minutes) | defrost (minutes) | (minutes) |
| ⁻18-0 | 15 | 15 | ≦15 |
| ⁻1-5 | 15 | 15 | ≦6 |
| 5-15 | 10 | 10 | ≦4 |
| >15 | 8 | 8 | ≦2 |

As will be appreciated, by use of an ambient temperature-dependent timer to determine a time of actuation of the HWS subsystem in auto mode, a lesser time of actuation and so reduced power usage is possible.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method for improving operation of a stop-start system of a vehicle, comprising controlling an electrical load delivered to an electrically heated windshield (HWS) subsystem of the vehicle prior to a stop cycle or a start cycle of the stop-start system.

2. The method of claim 1, including discontinuing the electrical load delivered to the HWS subsystem for a predetermined time period prior to a determined predicted stop cycle of the stop-start system.

3. The method of claim 1, including differently apportioning the electrical load delivered to a passenger's side and a driver's side of the HWS subsystem.

4. The method of claim 3, including reducing the electrical load delivered to the passenger's side of the HWS subsystem.

5. The method of claim 3, including differently apportioning the electrical load delivered to the passenger's side and the driver's side according to a determined ambient temperature value.

6. The method of claim 5, including differently apportioning the electrical load delivered to the passenger's side and the driver's side for a predetermined time period.

7. The method of claim 6, wherein the predetermined time period varies according to the determined ambient temperature value.

8. A stop-start system for a vehicle, comprising at least one controller for controlling an electrical load delivered from a vehicle battery to a plurality of electrical subsystems of the vehicle including at least an electrically heated windshield (HWS) subsystem;
wherein the controller is configured to alter an electrical load delivered to the HWS subsystem prior to a stop cycle or a start cycle of the stop-start system.

9. The stop-start system of claim 8, wherein the at least one controller is configured to discontinue the electrical load delivered to the HWS subsystem for a predetermined time period prior to a determined predicted stop cycle of the stop-start system.

10. The stop-start system of claim 8, wherein the at least one controller is configured to differently apportion the electrical load delivered to a passenger's side and a driver's side of the HWS subsystem.

11. The stop-start system of claim 10, wherein the at least one controller is configured to reduce the electrical load delivered to the passenger's side of the HWS subsystem.

12. The stop-start system of claim 11, wherein the at least one controller is configured to differently apportion the electrical load delivered to the passenger's side and the driver's side according to a determined ambient temperature value.

13. The stop-start system of claim 12, wherein the at least one controller is configured to differently apportion the electrical load delivered to the passenger's side and the driver's side for a predetermined time period.

14. The stop-start system of claim 13, wherein the predetermined time period varies according to the determined ambient temperature value.

15. The stop-start system of claim 14, wherein the predetermined time period is determined by an ambient temperature-dependent timer.

16. A vehicle including the stop-start system of claim 8.

17. A motor vehicle, comprising:
an engine;
a battery;
a stop-start system;
one or more electrical load subsystems including at least a heated windshield (HWS) subsystem; and
at least one controller for controlling an electrical load delivered from the battery to the HWS subsystem, wherein the controller is configured to alter an electrical load delivered to the HWS subsystem prior to a stop cycle or a start cycle of the stop-start system.

18. The motor vehicle of claim 17, wherein the at least one controller is configured to discontinue the electrical load delivered to the HWS subsystem for a predetermined time period prior to a determined predicted stop cycle of the stop-start system.

19. The motor vehicle of claim 17, wherein the at least one controller is configured to differently apportion the electrical load delivered to a passenger's side and a driver's side of the HWS subsystem according to a determined ambient temperature value and a predetermined time period.

20. The motor vehicle of claim 19, further including an ambient temperature-dependent timer for determining the predetermined time period.
